(19) United States
(12) Patent Application Publication
(10) Pub. No.: US 2026/0371166 A1
(43) Pub. Date: Nov. 19, 2026

(54) EXTENDED ACCESS PROCEDURE

(71) Applicant: Nokia Technologies Oy, Espoo (FI)

(72) Inventors: Ahlem KHLASS, Nozay (FR); Tao TAO, Shanghai (CN); Daniela LASELVA, Klarup (DK); Juha Sakari KORHONEN, Espoo (FI)

(21) Appl. No.: 19/103,267

(22) PCT Filed: Aug. 12, 2022
(86) PCT No.: PCT/CN2022/112321

§ 371 Date: Feb. 12, 2025

(51) Int. Cl. H04W 28/086; H04W 52/02

(52) U.S. Cl. CPC H04W 28/086; H04W 52/0206

(57) ABSTRACT

Embodiments of the present disclosure relate to devices, methods, apparatuses and computer readable storage media of an extended access. A first device transmits a first message to initiate a first access to a first cell. The first device receives an access response from at least one of the first cell or a different second cell. The access response indicates that the second cell is to be accessed by the first device. The first device transmits, to the second cell, a second message associated With a second access to the second cell.

### FIELD

Embodiments of the present disclosure generally relate to the field of telecommunication and, in particular, to devices, methods, apparatuses and computer readable storage media of an extended access procedure.

### BACKGROUND

Network (NW) energy savings may be focus on a radio access network (RAN) which consumes the largest part of total energy consumption in the network. Infrequent Synchronization Signal Block (SSB) transmission may be used to achieve NW energy savings. Discontinuous transmission (DTX) may also be used for NW energy savings. In an NW deployment, a coverage cell served with a Macro base station (BS) provides basic “underlay” coverage in a certain area of the network, and a capacity cell served with a small BS is overlaid over the coverage cell for capacity boosting purposes within a specific zone. Capacity cells may be inactive or switched Off during low load or empty periods to achieve network energy savings. The inactive or switched Off capacity cells may be (re)activated when needed.

### SUMMARY

In a first aspect, there is provided a first device. The first device comprises at least one processor; and at least one memory storing instructions that, when executed by the at least one processor, cause the first device at least to perform: transmitting a first message to initiate a first access to a first cell; receiving an access response from at least one of the first cell or a different second cell, the access response indicating that the second cell is to be accessed by the first device; and transmitting, to the second cell, a second message associated with a second access to the second cell.

In a second aspect, there is provided a second device. The second device comprises at least one processor; and at least one memory storing instructions that, when executed by the at least one processor, cause the second device at least to perform: receiving, in a first cell, from a first device, a first message to initiate a first access to the first cell; and determining that a different second cell is to be accessed by the first device.

In a third aspect, there is provided a third device. The third device comprises at least one processor; and at least one memory storing instructions that, when executed by the at least one processor, cause the third device at least to perform: determining that a second cell served by the third device is to be accessed by a first device, the first device having initiated a first access to a different first cell; and based on a determination that the second cell is to be accessed by the first device, detecting, from the first device, a second message associated with a second access to the second cell.

In a fourth aspect, there is provided a method implemented at a second device. The method comprises transmitting a first message to initiate a first access to a first cell; receiving an access response from at least one of the first cell or a different second cell, the access response indicating that the second cell is to be accessed by the first device; and transmitting, to the second cell, a second message associated with a second access to the second cell.

In a fifth aspect, there is provided a method implemented at a second device. The method comprises receiving, in a first cell, from a first device, a first message to initiate a first access to the first cell; and determining that a different second cell is to be accessed by the first device.

In a sixth aspect, there is provided a method implemented at a third device. The method comprises determining that a second cell served by the third device is to be accessed by a first device, the first device having initiated a first access to a different first cell; and based on a determination that the second cell is to be accessed by the first device, detecting, from the first device, a second message associated with a second access to the second cell.

In a seventh aspect, there is provided an apparatus comprising means for performing the method according to the above fourth, fifth, or sixth aspect.

In an eighth aspect, there is provided a non-transitory computer readable medium comprising program instructions for causing an apparatus to perform at least the method according to any one of the above fourth, fifth, or sixth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example environment in which example embodiments of the present disclosure may be implemented;

FIG. 2 illustrates an example signaling diagram of an access procedure according to some example embodiments of the present disclosure;

FIGS. 3A to 3D illustrates example processes of an extended access according to some other example embodiments of the present disclosure;

FIG. 4 illustrates a flowchart of an example method of an extended access in accordance with some example embodiments of the present disclosure;

FIG. 5 illustrates a flowchart of an example method of an extended access in accordance with some example embodiments of the present disclosure;

FIG. 6 illustrates a flowchart of an example method of an extended access in accordance with some other example embodiments of the present disclosure;

FIG. 7 illustrates a simplified block diagram of an apparatus that is suitable for implementing example embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry), and
(b) combinations of hardware circuits and software, such as (as applicable):
   (i) a combination of analog and/or digital hardware circuit(s) with software/firmware, and
   (ii) any portions of hardware processor(s) with software (including digital signal processor(s), software, and memory(ies) that work together to cause an apparatus, such as a mobile phone or server, to perform various functions), and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT), a 6G or any future standard and so on. Furthermore, the communications between a terminal device and a network device in the communication network may be performed according to any suitable communication protocols, including, but not limited to, cellular communication protocols such as the first generation (1G), the second generation (2G), 2.5G, 2.75G, the third generation (3G), the fourth generation (4G), 4.5G, the fifth generation (5G) cellular communication protocols, wireless local network communication protocols such as Institute for Electrical and Electronics Engineers (IEEE) 802.11 and the like, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be understood that the scope of the present disclosure will not be limited to only the aforementioned system.

As used herein, the term “base station” or (BS) refers to a device in a communication network via which a terminal device accesses the network and receives services therefrom. The base station may include a transmission/reception point (TRP), an access point (AP), a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto node, a pico node, an access point, and so forth, depending on the applied terminology and technology.

As used herein, the term “macro base station” or “macro BS” refers to a base station covering a larger area such as a coverage cell. Examples of the macro base station may include node B (NodeB or NB), an evolved NodeB (eNodeB or eNB), a NR NB (also referred to as a gNB). As used herein, the term “small base station” or “small BS” refers to a base station covering a smaller area such as a capacity cell. In some example embodiments, the small BS may support network energy savings and provide a cell that may be in an inactive, sleep, DTX or OFF mode for power savings.

In the context of the present disclosure, an active cell or a switched ON (or switched-on) or turned ON cell refers to a cell that has its (majority of) hardware components ON. The terms “active”, “switched ON” and “turned ON” may be interchangeably used. A switched OFF (or switched-off) cell, a turned OFF cell, a deactivated cell, an inactive cell, or a deep sleep cell refers to a cell that has all (majority of) components OFF. The terms “switched OFF”, “turned OFF”, “deactivated”, “inactive” or “deep sleep” may be interchangeably used. A sleeping cell or a cell in a sleep mode refers to a cell in an intermediate state in which the cell has some of its components ON while other components are switched OFF.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “terminal”, “user equipment” and “UE” may be used interchangeably.

Network (NW) energy savings may focus on a radio access network (RAN) which consumes the largest part of total energy consumption in the network. The NW energy savings may aim at identifying adaptation techniques of transmissions and/or receptions in time, frequency, spatial, and power domains, with potential support or feedback from user equipment (UE), potential UE assistance information, and information exchange or coordination over network interfaces.

NW energy savings may be achieved using infrequent Synchronization Signal Block (SSB) transmission. For example, SSB periodicity of 160 ms may be considered in an empty or low load situation in the fifth generation (5G) non-standalone (NSA) deployments. Micro Discontinuous transmission (DTX) may also be used for NW energy savings, which may comprise shutting down a power amplifier (PA) per OFDM symbol, for example, in symbols that carry neither data nor signaling. For the NW energy savings, further components such as a baseband (BB) circuity may be shut down. Alternatively, or in addition, even total cells may switch OFF or shut down. Such cell shutdown may allow to switch off most of hardware components of a RAN site.

In an NW deployment, a coverage area of a cell (also referred to as a coverage cell) served with a Macro base station (BS) provides basic “underlay” coverage in a certain area of the network. Small cells (also referred to as capacity cells) served with a small BS are overlaid over the coverage cell for capacity boosting purposes particularly within so-called “hot spot zones”. UEs may be served by a coverage cell or by a capacity cell. Capacity cells may be inactive or switched Off during low load or empty periods to achieve network energy savings. All active components of the cells may be turned off to achieve energy consumption reduction.

The time taken by a component to switch OFF or ON to achieve capacity cell deactivation or activation may be rather long. In this case, an intermediate state, sleeping state, may be defined in which some (or even most) components are switched OFF while some other are activated upon needs. For example, the PA may be activated occasionally to schedule lean signaling, such as beacons or synchronization system blocks (SSBs), for cell discovery, while switching off the main receiver and other components to save energy.

The cell activation may be controlled by the network. A cell activation request from a neighbor node, for example, a cell activation procedure over an Xn or X2 interface, may be used to trigger a switched-off cell to (re-)activate. The trigger for cell activation may be based on a load of a cell and a need to offload some traffic of the cell to one or more cells that are currently switched OFF. The trigger for cell activation may be based on an aggregated load across a cluster of cells (which are also referred to as a power saving group), such as the load of the cells comprising a coverage layer or a certain frequency layer.

Example embodiments of the present disclosure propose an extended access scheme which extends an access procedure initiated by a first device (such as a terminal device) towards a cell (referred to as a first cell) to a different cell (referred to as a second cell). In some example embodiments, the first cell may be a coverage cell, and the second cell may be a capacity cell in an inactive, sleep, DTX or OFF state or mode. With this scheme, after the first device transmits a message (referred to as a first message) to initiate an access (referred to as a first access) to the first cell, the first message may be received or detected in at least one of the first or second cell. The first message may comprise any type and/or form of messages that is used to initiate the first access. For example, the first message may comprise Message 1 (Msg1) of a 4-step random access (RA) procedure, Message A (MSGA) of a 2-step random access procedure, and/or the like. The first message may be implemented in a form of a given sequence such as a Physical Random Access Channel (PRACH) preamble sent over a PRACH channel, a wake-up signal over other channels, and/or the like.

From the at least one of the first or second cell, the first device receives an access response such as a random access response (RAR) or message 2 (e.g. Msg 2 of the 4-step random access (RA) procedure). The access response indicates that the second cell is to be accessed by the first device. Further, the first device transmits a message (referred to as a second message) associated with an access (referred to as a second access) to the second cell. The second message may comprise any type and/or form of messages that is associated with the second access. For example, the second message may comprise Message 3 (Msg3) of the 4-step random access procedure as a response to a RAR or Msg 2, Msg1 to initiate a new random access procedure, a wake-up signal or indication sent using an existing or new signal or channel, and/or the like.

In this way, after a device (such as a UE) requests for a cell to provide a service, a different cell may be enabled or activated to provide the service based on the needs of the requesting device (such as traffic or service needs, radio conditions, and/or the like). This may be more flexible and practical and may improve a probability of a successful access and further increase network performance or efficiency.

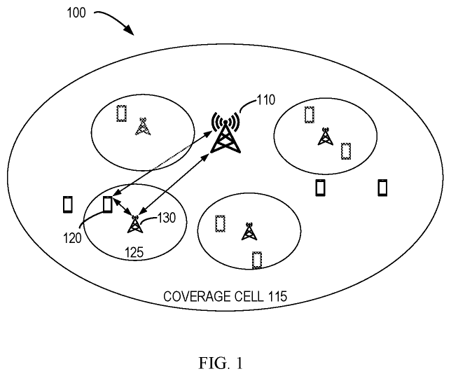

FIG. 1 illustrates an example environment 100 in which example embodiments of the present disclosure may be implemented.

The environment 100, which may be a part of a communication network, includes a macro BS 110 that serves a coverage cell 115. Within the coverage cell 115, there are a plurality of terminal devices and a plurality of small BSs. As shown in FIG. 1, a terminal device 120 is located within both the coverage cell 115 and a capacity cell 125 served by a small BS 130. The coverage cell 115 may provide basic coverage in the environment 100, and the capacity cell 125 is overlaid over the coverage cell 115 for capacity boosting. The terminal device 120 may be served by the coverage cell or by a capacity cell.

It is to be understood that the numbers of macro BSs, small BSs and terminal devices are shown in FIG. 1 only for the purpose of illustration without suggesting any limitations. The environment 100 may comprise any suitable number of macro BSs, small BSs and terminal devices adapted for implementing example embodiments of the present disclosure. Any suitable number of small BSs and terminal devices may be located in a coverage area of each of the macro BSs.

It is also to be understood that the small BS 130 is shown to be physically separate from the macro BS 110 only for the purpose of illustration. The small BS 130 may have any suitable positioning relationship with the macro BS 110. Accordingly, the capacity cell 125 may be overlaid over the coverage cell 115 in any suitable pattern to improve capacity of any “hot spot zones”. In some example embodiments, the small BS 130 may be collocated with or even implemented as a part of the macro BS 110. In these embodiments, the capacity cell 125 and the coverage cell 115 may be concentric or collocated.

The terminal device 120 may communicate with the macro BS 110 or communicate with the small BS 130 directly or via the macro BS 110. The terminal device 120 may communicate with another terminal device directly or via the BS 110 and/or 130. The small BS 130 may communicate with the macro BS 110 over wireless and/or wired means. As an example, the terminal device 120 and the two BSs 110 and 130 may communicate via a Uu interface, and the two BSs 110 and 130 may communicate via an Xn or X2 interface.

Communications in the environment 100 may utilize any suitable wireless communication technology, including, but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM), Bluetooth, ZigBee, machine type communication (MTC), enhanced mobile broadband (eMBB), massive machine type communication (mMTC), ultra-reliable low latency communication (URLLC), Carrier Aggregation (CA), Dual Connection (DC), New Radio Unlicensed (NR-U), Small Data Transmission (SDT), and/or any other technologies currently known or to be developed in the future.

Within the coverage cell 115, a plurality of capacity cells may be turned ON or OFF depending on network needs, for example, to offload the traffic of the macro BS 110, to boost the capacity of the coverage cell 115, and/or the like. The capacity cell 125 may be in a power saving state (such as an inactive, sleeping, OFF, and/or DTX state or mode) during a low load or empty period of the coverage cell 115 to achieve network energy savings. All active components of the capacity cell 125 may be deactivated to achieve energy consumption reduction. In the power saving state, no paging procedure, no PRACH, or no SSB or SIB may be supported in the capacity cell 125 which may be waiting for an activation request.

In the environment 100, the terminal device 120 may be camping in the coverage cell 115, but in an inactive or idle state such as a Radio Resource Control (RRC) inactive or idle state. Triggered by the presence of uplink (UL) and/or downlink (DL) data and/or signaling, the terminal device 120 may initiate an access to the coverage cell 115. The access to coverage cell 115 may be extended to the capacity cell 125.

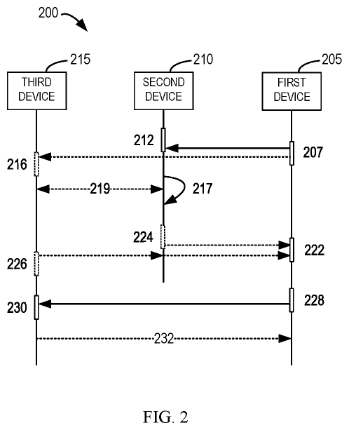

Example embodiments of such access extension will be discussed below with reference to FIGS. 2-6.

FIG. 2 shows an example signaling diagram 200 of an access procedure according to some example embodiments of the present disclosure. For the purposes of discussion, the diagram 200 will be discussed with reference to FIG. 1.

In the diagram 200, a first device 205 (such as the terminal device 120) transmits (207) a first message to initiate a first access to a first cell (such as the coverage cell 115). A second device 210 (such as the macro BS 110), which serves the first cell, receives (212) the first message.

In some example embodiments, the third device 215 serving a second cell (such as the capacity cell 125) may also receive (216) the first message. Coordination between the second and third devices 210 and 215 may be needed such that the third device 215 may acquire a configuration of the first message to receive this message. For example, the second device 210 may send, to the third device 215, an indication of a resource for detecting the first message from the first device 205. The resource may comprise resources in time, frequency, special and/or code domains. As such, the third device 215 may know which time and/or frequency resource, which beam, and/or which preamble may be used by the first device 205 to transmit the first message. Further, the third device 215 may detect the first message from the first device 205 using the resource indicated by the second device 210.

The second and third devices 210 and 215 may have any suitable positioning relationship. The two devices 210 and 215 may be either separate from each other or collocated with each other. In some example embodiments, the third device 215 may be implemented as a part of the second device 210. Accordingly, the second cell may be separate from, partially overlapped with, overlaid over, or concentric or collocated with the first cell.

It is to be understood that the first, second, and third devices 205, 210, and 215 may be implemented by any suitable devices. Some example embodiments are discussed by taking the terminal device 120 as an example of the first device 205, the macro BS 110 as an example of the second device 210, and the small BS 130 as an example of the third device 215. Other implementations of these devices 205, 210, and 215 are also possible, and the scope of the present disclosure will not be limited in this regard. As an example, the second and third devices 210 and 215 may be any other devices that can cover an area to support a service to the first device 205. The first device 205 may be any other device that needs to have access to the coverage areas of the second and third devices 210 and 215 to obtain a requested service.

The first message for initiating the first access to the first cell may comprise any suitable type of messages in any suitable form. In some example embodiments, the first device 205 may initiate a RA procedure to access the first cell. For example, in response to an event trigger, the first device 205 may initiate a contention based random access (CBRA) procedure or a 4-step RA procedure or initiate a contention free random access (CFRA) procedure or a 2-step random access procedure. The first message may comprise Msg1 in the 4-step RA procedure or MSGA in the 2-step random access procedure. The first message may be implemented in a form of a given sequence such as a preamble sent over a PRACH channel or other channels, a wake-up signal, and/or the like.

After receiving (212) the first message, the second device 210 determines (217) that the second cell is to be accessed by the first device 205. In some example embodiments, the second device 210 may make the decision by itself. The decision may be made by the second device 210 by considering a traffic type requested by the first device 205. For example, the second device 210 may identify a traffic type or service type requested by the terminal device 210. The traffic type or service type may be indicated by the first message. For example, in the example embodiments where the first device 205 initiates a RA procedure for the first access to the first cell, the first device 205 may select a preamble or certain PRACH resources associated with the requested traffic type. Accordingly, the second device 210 may determine the requested traffic type based on the selected preamble or resources.

As an example, if the requested traffic is delay-tolerant traffic, which means that the traffic is not so urgent, then the second device 210 may decide to switch the access from the first cell to the second cell since such switching may need some processing time. If the traffic is URLLC traffic, the second device 210 may determine no such switching.

As another example, if the first device 205 selects Small Data Transmission (SDT)-specific PRACH resources and only a small data exchange is requested or expected, the second device 210 may decide not to switch the access. If a relatively large data exchange is requested, the second device 210 may determine that the second cell is to be accessed by the first device 205.

In some example embodiments, the decision may be made based on a load of the first and/or second cell. For example, if the load of the first cell is relatively large and/or the load of the second cell is relatively small, it may be determined that the second cell is to be accessed. If the load of the first cell is relatively small and/or the load of the second cell is relatively large, the second cell may not be accessed.

Alternatively, or in addition, the decision may be based on a location of the first device 105. Any suitable positioning techniques may be used to determine or estimate the location of the first device 105. In some example embodiments, the second device 210 may determine the location of the first device 105 based on Time of Arrival (ToA) and Angle of Arrival (DL-AoA) measurements on signals received from the first device 205 in a channel such as a PRACH. Based on the location of the first device 105, the second device 210 may determine whether the second cell is to be accessed. For example, if the first device 205 is located in the second cell, the second cell will be accessed by the first device 205. Otherwise, the first device 205 may still have access to the first cell.

Alternatively, or in addition, the second device 210 may make the decision based on radio conditions associated with the first and/or second cell. The radio conditions may be determined or evaluated based on channel estimations for communication channels with the first device 205. Any suitable channel estimation approaches or algorithms may be used, and the scope of the present disclosure will not be limited in this regard. As an example, one of the first and second cells with better radio conditions may be accessed by the first device 205.

In some example embodiments, after determining (217) that the second cell is to be accessed by the first device 205, the second device 210 may transmit to the third device 215 an indication that the second cell is to be accessed by the first device 205. This indication may comprise an identification of the first device 205 such that the third device 215 may identify a subsequent message from the first device 205. As an example, the second device 210 may forward the first message to the third device 210 as the indication. Other implementations of the indication may be possible. Some other implementations of the indication will be discussed in the following paragraph.

In some example embodiments, the second cell (such as a capacity cell) may be in a power saving state, such as an inactive, sleeping, OFF, and/or DTX state for energy saving. In these example embodiments, the second device 210 may send to the third device 215 a request for activating the second cell. Then, the third device 215 may activate the second cell. The request may be communicated via an Xn or X2 interface in the case that the second and third devices 210 and 215 are implemented by the macro BS 110 and the small BS 130, respectively.

After the second cell is activated, the third device 215 may broadcast at least synchronization signal block (SSB) in the second cell such that the first device 205 may acquire synchronization with the second cell subsequently. The third device 215 may further broadcast a system information block (SIB) in the second cell such that the first device 205 may acquire necessary information for the subsequent communication.

Alternatively, or in addition, the second device 210 may coordinate (212) with the third device 215 to make the decision. For example, in the example embodiments where the third device 215 may receive (214) the first message, the second and third devices 210 and 215 may coordinate with each other based on a load of the first and/or second cell, a traffic type requested by the first device, a location of the first device, and/or radio conditions associated with the first and/or second cell, and/or the like.

After it is determined that the second cell is to be accessed, the first device 205 receives (207) an access response that indicates that the second cell is to be accessed by the first device 205. In some example embodiments, the access response received by the first device 205 may comprise an identification of the second cell such as a Physical Cell Identifier (PCI) to indicate which cell is to be accessed. The access response may be implemented in any suitable messages. For example, in the example embodiments where a RA procedure is initiated by the first device 205, the access response may comprise a Random Access Response (RAR) message that may be implemented in message 2 (Msg 2) in the 4-step RA procedure, and/or Message B (MsgB) in the 2-step RA procedure.

The access response may be extended to indicate that the second cell (instead of the first cell) is to be accessed. For example, the access response may comprise an information element (IE) to indicate that the first device 205 may need to complete the remaining steps of the access procedure with the second cell. In the case that the 4-step RA procedure is used, the steps may comprise the transmission of Msg3, monitoring for Message 4 (Msg4), and/or the like. Other procedures, including NW synchronization, system information block 1 (SIB1), and/or the like, may also be completed in the second cell.

In some example embodiments, if the second cell (such as a capacity cell) may be in a power saving state, such as an inactive, sleeping, OFF, and/or DTX state for energy saving, the access response may further comprise an indication of availability time of the second cell to indicate to the terminal device when the second cell is available or activated to further improve the probability of a successful access to the second cell. The availability time may depend on the specific state or mode of the second cell at the time of reception of the first message and/or on a capability of fast reactivation for the second cell.

Alternatively, or in addition, the access response may comprise an indication of a resource, beam and/or timing for access to the second cell. Based such an indication, the first device 205 may have access to the second cell.

The access response may be received by the first device 205 from the first and/or second cells. As shown in FIG. 2, as an example, the second device 210 may transmit (224) the access response to the first device 205. As a response to the first message received from the first device 205, the second device 210 may generate the access response and then send it to the first device 205. In the case that the terminal device 120 acts as the first device 205 and the macro BS 110 acts as the second device 210, the access response may be transmitted from the second device 210 to the first device 205 via a Uu interface.

In some example embodiments, the second device 210 may transmit the access response to the third device 215. The access response may be used as an indication that the second cell will be accessed by the first device 205. In the example embodiments where the access response comprises a configuration for communication with the first device 205, the third device 215 may use this configuration for the future communication.

In some example embodiments, the access response may be generated by the third device 215. As shown in FIG. 2, the third device 215 may transmit (226) the access response to the first device 205 directly or via the second device 210. For example, after the third device 215 detects from the first device 205 the first message to initiate the first access to the first cell and further determines that the first device 205 is to access the second cell, the third device 215 may transmit the access response to the first device 205 from the second cell.

In some example embodiments, the second device 210 may forward the access response from the second cell to the first device 205. For example, the third device 215 may send the access response to the second device 210, and then the second device 210 relays it to the first device 205.

In some example embodiments, the first device 205 may receive an indication of a resource associated with the second cell and used for receiving the access response from the first and/or second cell. The resource may comprise resources in time, frequency, spatial and/or coding domain. As an example, the resource may comprise a search space for a Physical Downlink Control Channel (PDCCH) or other control channels in the second cell.

For example, the second device 210 may transmit the indication to the first device 205 via system information (SI) and/or radio resource control (RRC) signaling. As another example, the third device 215 may transmit the indication to the first device 205 in the second cell via a SSB and/or a SIB after the second cell leaves a DTX or sleep state.

Accordingly, the first device 205 may monitor for the indicated resource to receive the access response from the second cell. The first device 205 may also monitor for a resource associated with the first cell to receive the access response from the first cell.

After receiving (222) the access response, the first device 205 transmits (228) a second message associated with the second access to the second cell. Accordingly, the third device 215 receives (230) the second message. To facility the communication of the second message, the access response may comprise an indication of a resource for transmitting the second message by the first device 205.

Alternatively, or in addition, the access response may comprise an indication of a beam and/or timing advance (TA) for the transmission of the second message. For example, the second device 210 may position the first device 205 based on ToA and/or AoA measurements. Then, the second device 210 may estimate a distance between the first device 205 and the second cell. By doing this, the second device 210 may determine a TA and a potential beam for the transmission of the second device 210 in the second cell. In some other embodiments, if the first cell and the second cell are co-located, the TA obtained based on the measurements in the first cell may also be valid for the second cell.

In some embodiments, if the availability time of the second cell is indicated to the first device 205, the first device 205 may first determine whether the second cell is available. When the second cell is available, the first device 205 may transmit the second message to the second cell. Before the transmission of the second message, the first device 205 may detect from the second cell at least a SSB for network synchronization. The first device 205 may further detect a SIB to acquire necessary information for communication with the third device 210 in the second cell.

The second message may comprise any suitable type of messages in any suitable form. In some example embodiments, the second message may be Msg3 in the 4-step RA procedure or any other message containing an identification of the first device 205 for contention resolution. If Msg 3 is used as an example of the second message, the transmission of Msg3 may be done targeting the second cell as a receiving cell.

After receiving (230) the second message, the third device 215 may transmit (232) a response message to the first device 205. In the embodiments where Msg3 is transmitted as the second message, the third device 215 may transmit Msg4.

In some example embodiments, the second message may be Msg1 in the 4-step RA procedure, MSGA in the 2-step RA procedure, or any other message to initiate the second access to the second cell. For example, if Msg1 is transmitted by the first device 205 as the second message towards the second cell, the third device 215 may responded with Msg2 from the second cell. If the first and second cells are co-located, the first device 205 may transmit Msg1 towards the capacity cell using a beam direction for the first message to initiate the first access to the first cell.

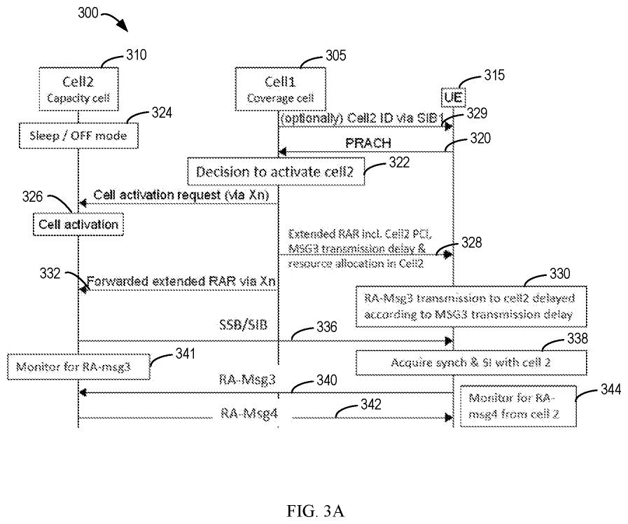

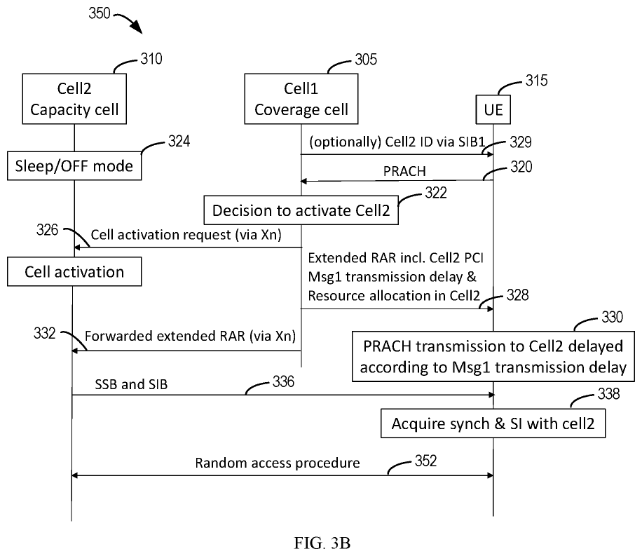

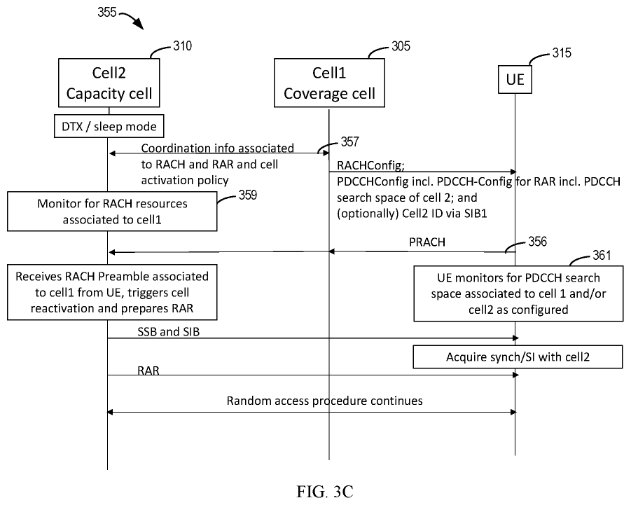

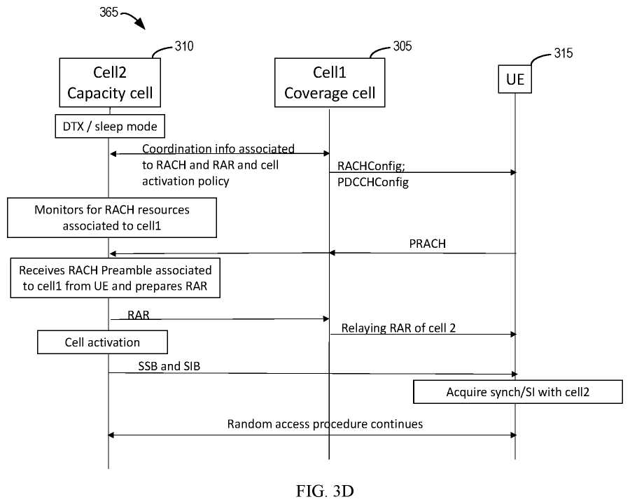

In some embodiments, if a RA procedure is used by the first device 205 (such as a UE) towards a coverage cell (as an example of the first cell), the RA procedure may be extended for the purpose of activation of a capacity cell (as an example of the second cell). In such extended RA procedure, the first device 205 may initiate a RACH procedure in the coverage cell (by sending the PRACH to the coverage cell), and the first device 205 may transmit or receive at least one RACH message (for example, one of the 4-step RACH messages) to/from the capacity cell. Some embodiments of two-cell process based on a RA procedure will be discussed below with reference to FIGS. 3A, 3B, 3C and 3D.

Reference is first made to FIG. 3A which shows a first example process 300 of an extended access according to some example embodiments of the present disclosure.

In this example, a coverage cell 305 (labeled as Cell1) and a capacity cell 310 (labeled as Cell2) are examples of the first and second cells. A UE 315 acts as the first device 205. The UE 315 may communicate Msg1 and an extended Msg 2 (of the 4-step RACH) with the coverage cell, and Msg3 and Msg4 with the capacity cell. As an example, the UE 315 may be configured with the extended two-cell RACH mode and receive a corresponding configuration to ensure that the UE 315 may know in which cell and in which resources the UE 315 may monitor for a PDCCH or a Physical Downlink Shared Channel (PDSCH) that carries the RACH messages.

As shown in FIG. 3A, triggered by the presence of UL/DL data, the UE 315 may initiate (320) a RA procedure by sending a Physical Random Access Channel (PRACH) preamble towards the coverage cell 305. In one example, the service type requested by the UE 315 may be identified by the network from the selected preamble.

It may be decided at 322 to activate the capacity cell 310, which is in a sleep or OFF mode at 324. Then, a cell activation request may be sent (326) to the capacity cell 310 (for example, through Xn signaling). In one example, this activation decision may be based on the load of the NW. In addition, or alternatively, this decision may be based on the traffic type requested by the UE 315, for example, whether the request may be triggered for delay-tolerant traffic. In addition, or alternatively, the decision and the selection of the capacity cell may depend on UE location that may be determined based on the received PRACH. In one example, the access request may be forwarded from the UE 315 to the capacity cell 310.

An extended Random-access response (RAR) message may be generated in the coverage cell 305 as a response to the PRACH reception. The extended RAR message may be sent (328) to the UE 315. The extended RAR message may comprise an indication to the UE 315 that the extended RACH mode is enabled, in which the UE 315 may have to transmit Msg3 of the RACH procedure to another cell (cell2), different from the cell providing the RAR message (cell1), and monitor for Msg4 from that cell (cell2).

In some embodiments, the extended RAR message may comprise a new IE, for example, “Capacity Cell Mode” IE (or “Extended RACH mode” or “two-cell RACH mode”) including a PCI of the capacity cell 310 (as an example of an identification of the capacity cell 310), to indicate that UE 315 may need to complete the remaining steps of the RACH procedure with a given capacity cell. In addition, other procedures, including NW synchronization, SIB1 acquisition, monitoring occasions for Msg4, may also be completed in the capacity cell 310.

In some example embodiments, the presence of the capacity cell 310 may be indicated from the coverage cell 305 via System information (SI). In one example, the indication may comprise the capacity cell ID. In one option, the indication may be provided in SI. In another option, the indication may be provided in RRC signaling, such as Paging message. As shown in FIG. 3A, as an alternative example, the Cell2 ID may be transmitted (329) via SIB1 from the coverage cell 305 to the UE 315.

If the UE 315 may have to send Msg3 to the capacity cell according to the configured extended RACH mode, a timing advance (TA) for the transmission of Msg3 (or Msg3 transmission delay) may be calculated and provided to the UE 315 as part of the RAR message based on information on the capacity cell. For example, ToA and AoA measurements may be performed on the received PRACH, and then a coarse location of the UE may be determined. Based on the location of capacity cell, a distance between the UE 315 and the capacity cell 310 may be estimated. By doing this, a TA and also a potential beam may be determined for the UE 315 to use in the capacity cell 310. In another embodiment, if the coverage cell 305 and the capacity cell 310 are co-located, the TA obtained based on PRACH in the coverage cell 305 may be also valid for the capacity cell 310.

In some example embodiments, an indication of availability time of the capacity cell 310, which may depend on the sleep mode in which the capacity cell 310 is at the time of the PRACH reception and on the capability of fast reactivation of the capacity cell 310, may also be included in the extended RAR message and provided to the UE 315. An indication of resource allocation of the capacity cell 310 may also be included in the extended RAR message.

Which message(s) should be monitored or transmitted to a different cell in a given extended RACH mode may be defined in the standards or provided in the RAR message or configured in the SIB of the coverage cell 305. The extended RAR may be transmitted from the coverage cell 305 to the UE 315 via a Uu interface and to the capacity cell 310 via an Xn interface.

The UE 315 may receive the extended RAR message and apply the received information or configuration related to the extended RACH mode. For example, the UE 315 may take into consideration the availability time of the capacity cell 310, if received, before the Msg3 transmission to the capacity cell 310. As shown in FIG. 3A, at 330, PRACH transmission to Cell2 may be delayed according to Msg1 transmission delay.

The RAR message that may be received (332) in the capacity cell 310 may contain the Msg3 resource allocation provided to the UE 315, based on which monitoring for the Mgs3 from the UE 315 may be performed in the capacity cell 310. For example, the RAR message may inform the capacity cell 310 about when and where Msg3 may be received from the UE 315 in the capacity cell 310, which temporary C-RNTI (TC-RNTI) the UE 315 may be assigned and used in Msg3.

Once (re-)activated, reference signals such as SSBs and optional SIB may be sent (336) from the capacity cell 310, which may be received by the UE 315 and used to acquire (338) network synchronization and SI.

After synchronizing with the capacity cell 310 and acquiring necessary information from SIB, the UE 315 may send (340) Msg3 to the capacity cell 310 and completes RRC connection establishment towards the capacity cell 310. The transmission of Msg3 may be done targeting the capacity cell 310 as a receiving cell. This may include that a Media Access Control I (MAC-I) token for RRC-level integrity protection may be generated and populated in a RRC Resume Request message of the UE 315 in a RRC Inactive mode using the PCI of the capacity cell 310.

In one example, the transmission of Msg3 may be done using a UE Tx beam based on the best UE Tx beam towards the coverage cell 305. This may assume co-location between the coverage and capacity cells 305 and 310 and FR1 operation. In one example, the UE 315 may use the same UE Tx beam for Msg3 transmission as used for the PRACH transmission. In the co-location FR1 case, the Rx and Tx beams of the UE towards the two cells 305 and 310 may be considered the same. In another example, the transmission of Msg3 may be done using a UE Tx beam indicated in the RAR message, based on the mapping of the UE Tx beam in the coverage cell 305 to the UE Tx beam in the capacity cell 310. For example, same or wider beams may be used in the capacity cell 310 compared to the coverage cell 305.

Msg3 may be monitored (341) for in the capacity cell 310. Then, Msg4 may be transmitted (342) from the capacity cell 310 to the UE 315. The UE 315 may monitor (344) for Msg4 from the capacity cell 310.

FIG. 3B shows a second example process 350 of an extended access according to some example embodiments of the present disclosure.

In this example, the PRACH and the RAR may be sent to/from the coverage cell 305, followed by the transmissions of Msg1, 2, 3 and 4 in the capacity cell 310.

The actions and operations at 320 to 338 in the second process 350 may be similar to those in the first process 300. The difference is that in the extended RACH mode of the process 350, the UE 315 may have to perform a random access in the capacity cell 310 (cell2).

In this example, the extended RAR message may comprise PRACH resource information for the capacity cell 310. This may include all the PRACH information that may be in a SIB (but UE may not need to read that SIB from the capacity cell 310) and/or a dedicated preamble assignment for contention free random access.

The extended RAR message received at 332 may indicate that the UE 315 may be going to transmit on a PRACH and the PRACH resource that will be used. The message may inform the capacity cell 310 about when and where the capacity cell 310 may be able to receive Msg1 from the UE 315.

After synchronizing with the capacity cell and acquiring necessary information from SIB, at 338 the UE 315 may initiate (352) a random access and complete RRC connection establishment towards the capacity cell 310.

FIG. 3C shows a third example process 355 of an extended access according to some other example embodiments of the present disclosure.

In the third process 355, the UE 315 may try (356) a RA to the coverage cell 305 by sending a preamble on the PRACH and waiting for a RA response. The PRACH may be listened to in both the coverage and capacity cells 305 and 310, and the UE 315 may be responded from the capacity cell 310.

The capacity cell 310 may coordinate (357) with the coverage cell 305. Coordination with the coverage cell 305 may be needed to agree which cell may be used to respond to the UE 315. Also, coordination may be needed for the capacity cell 310 to acquire a RACH configuration of cell1 in order to be able to monitor (359) for the RACH initiated to cell 1.

The UE 315 may monitor (361) for a PDCCH search space associated to the coverage cell 305 and/or the capacity cell 310 in order to receive the RAR from cell 2. The need to monitor for the RAR from cell 2 and the associated configuration may be provided from cell 1. Alternatively, the UE 315 may start monitoring for the RAR from cell 2 upon an implicit or explicit indication of cell2. An example of implicit indication may be the transmission of a SSB or SIB from cell2.

FIG. 3D shows a fourth example process 365 of an extended access according to some other example embodiments of the present disclosure.

The fourth process 365 in FIG. 3D is similar to the third process 355 in FIG. 3C. The difference is that the RA response may be prepared in the capacity cell 310 and sent via the coverage cell 305. The decision that the UE 315 may be responded from the capacity cell 310 may depend on the service requested by the UE 315, which may be indicated by the PRACH resource selected by the UE 315. For example, if the UE 315 selects SDT-specific PRACH resources and only a small data exchange is expected, then cell2 may not be reactivated and cell1 may be used to respond to the RACH. Vice-versa, if a relatively large data exchange is expected, and/or based on the load of Cell1, Cell2 may be requested to respond the PRACH from the UE 315.

In some example embodiments, the RA procedure may be leveraged to enable a timely and efficient activation of a sleeping cell based on the needs and conditions of the UE (such as traffic needs, radio conditions, and/or the like). By doing so, a sleeping cell may be activated based on the actual needs or conditions of a UE rather than based on an increase of a average load level in a larger geographical area such a coverage cell.

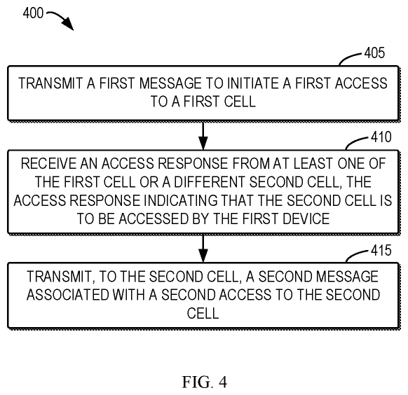

FIG. 4 shows a flowchart of an example method 400 of an extended access in accordance with some example embodiments of the present disclosure. The method 400 may be implemented at the first device 205 as shown in FIG. 2. For the purposes of discussion, the method 400 will be described from the perspective of the first device 205 with reference to FIGS. 1 and 2.

At block 405, the first device 205 transmits a first message to initiate a first access to a first cell. At block 410, the first device 205 receives an access response from at least one of the first cell or a different second cell, the access response indicating that the second cell is to be accessed by the first device. At block 415, the first device 205 transmits, to the second cell, a second message associated with a second access to the second cell.

In some example embodiments, the access response may comprise at least one of: an identification of the second cell, an indication of a resource (referred to as a first resource) for transmitting the second message by the first device, an indication of availability time of the second cell, an indication of a beam for the transmission of the second message, or an indication of a timing advance for the transmission of the second message.

In some example embodiments, to transmit the second message, the first device 205 may determine, based on the availability time of the second cell, that the second cell is available; and based on a determination that the second cell is available, transmit the second message to the second cell.

In some example embodiments, the first device 205 may receive an identification of the second cell from the first cell via at least one of system information or radio resource control signaling.

In some example embodiments, to receive the access response, the first device 205 may monitor for a resource (referred to as a second resource) associated with the at least one of the first or second cell to receive the access response.

In some example embodiments, the second resource may comprise a resource associated with the second cell. In some example embodiments, the first device 205 may receive an indication of the resource associated with the second cell from at least one of the first or second cell.

In some example embodiments, to receive the indication of the resource associated with the second cell, the first device 205 may receive the indication of the resource associated with the second cell from the first cell via at least one of system information or radio resource control signaling.

In some example embodiments, to receive the indication of the resource associated with the second cell, the first device 205 may receive the indication of the resource associated with the second cell from the second cell via at least one of a synchronization signal block or system information.

In some example embodiments, to transmit the second message, the first device 205 may transmit, to the second cell, the second message using a beam, the beam comprising at least one of: a beam used for transmitting the first message for initiating the first access to the first cell, or a beam indicated by the access response.

In some example embodiments, the first device 205 may further before transmitting the second message, detect, from the second cell, at least a synchronization signal block.

In some example embodiments, to detect at least the synchronization signal block, the first device 205 may detect, from the second cell, the synchronization signal block and a system information block.

In some example embodiments, the second message may comprise at least one of: message 3 in a first random access procedure for the first access to the first cell, or message 1 in a second random access procedure for the second access to the second cell.

In some example embodiments, the first cell may comprise a coverage cell, and the second cell may comprise a capacity cell.

FIG. 5 shows a flowchart of an example method 500 of an extended access in accordance with some example embodiments of the present disclosure. The method 500 may be implemented at the second device 210 as shown in FIG. 2. For the purposes of discussion, the method 500 will be described from the perspective of the second device 210 with reference to FIGS. 1 and 2.

At block 505, the second device 210 receives, in a first cell, from a first device 205, a first message to initiate a first access to the first cell. At block 510, the second device 210 determines that a different second cell is to be accessed by the first device 205.

In some example embodiments, the second device 210 may further transmit, to the first device 205, an access response from at least one of the first cell or a different second cell, the access response indicating that the second cell is to be accessed by the first device 205.

In some example embodiments, the access response may comprise at least one of: an identification of the second cell, an indication of a first resource for transmitting, by the first device, a second message associated with a second access to the second cell, an indication of availability time of the second cell, an indication of a beam for the transmission of the second message, or an indication of a timing advance for the transmission of the second message.

In some example embodiments, to transmit the access response, the second device 210 may generate the access response; and transmit, to the first device 205, the (random) access response from the first cell.

In some example embodiments, the second cell may be in a sleep or OFF mode. In some example embodiments, the second device 210 may further transmit, to a third device 215 serving the second cell, a request for activating the second cell.

In some example embodiments, the second device 210 may further transmit, to a third device 215 serving the second cell, an indication that the second cell is to be accessed by the first device.

In some example embodiments, the second device 210 may further transmit, to a third device 215 serving the second cell, at least one of: an identification of the first device, an indication of a first resource for transmitting, by the first device, a second message associated with a second access to the second cell, or an indication of a timing advance for the transmission of the second message.

In some example embodiments, the second message comprises at least one of: message 3 in a first random access procedure for the first access to the first cell, or message 1 in a second random access procedure for the second access to the second cell.

In some example embodiments, the second device 210 may further receive the access response from a third device serving the second cell. In some example embodiments, to transmit the access response, the second device 210 may transmit, to the first device 205, the access response from the second cell.

In some example embodiments, the second device 210 may further transmit, to the third device 215, an indication of a resource (referred as a third resource) for detecting, from the first device, the first message to initiate the first access to the first cell.

In some example embodiments, the second device 210 may further transmit, to the first device 205, an indication of a resource associated with the second cell and used for receiving the access response, via at least one of system information or radio resource control signaling.

In some example embodiments, the second device 210 may further transmit, to the first device 205, an identification of the second cell via at least one of system information or radio resource control signaling.

In some example embodiments, the determining may be performed based on at least one of: a load of the first and/or second cell, a traffic type requested by the first device, a location of the first device, or radio conditions associated with the first and/or second cell.

In some example embodiments, the determining is performed according to coordination with the second cell.

In some example embodiments, the first cell may comprise a coverage cell, and the second cell may comprise a capacity cell.

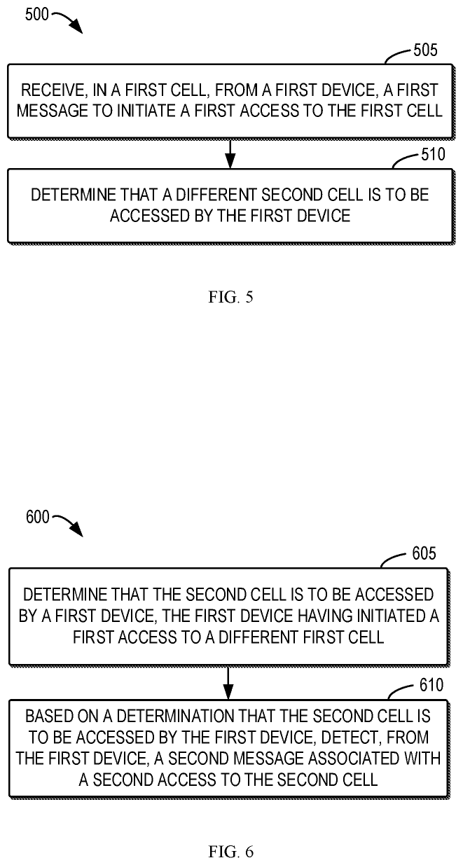

FIG. 6 shows a flowchart of an example method 600 of an extended access in accordance with some example embodiments of the present disclosure. The method 600 may be implemented at the third device 215 as shown in FIG. 3. For the purposes of discussion, the method 600 will be described from the perspective of the third device 215 with reference to FIGS. 1 and 2.

At block 605, the third device 215, which serves a second cell, determines that the second cell is to be accessed by a first device 205. The first device 205 has initiated a first access to a different first cell. At block 610, based on a determination that the second cell is to be accessed by the first device 205, the third device 215 detecting, from the first device 205, a second message associated with a second access to the second cell.

In some example embodiments, to determine that the second cell is to be accessed by the first device, the third device 215 may receive, from a second device 210 serving the first cell, an indication that the second cell is to be accessed by the first device; and based on the reception of the indication, determine that the second cell is to be accessed by the first device 205.

In some example embodiments, the second cell is in a sleep or OFF mode. In some example embodiments, the third device 215 may further receive, from the second device, a request for activating the second cell; and based on the reception of the request, activate the second cell.

In some example embodiments, the third device 215 may further broadcast at least a synchronization signal block in the second cell.

In some example embodiments, to broadcast at least the synchronization signal block, the third device 215 may broadcast the synchronization signal block and a system information block in the second cell.

In some example embodiments, the third device 215 may receive, from the second device 210, at least one of: an identification of the first device 205, an indication of a first resource for transmitting the second message by the first device, or an indication of a timing advance for the transmission of the second message.

In some example embodiments, to determine that the second cell is to be accessed by the first device 205, the third device 215 may receive, from the second device 210, an indication of a third resource for detect, from the first device 205, a first message to initiate the first access to the first cell; detecting the first message from the first device 205 using the third resource; and based on the detection of the first message, determine that the second cell is to be accessed by the first device 205.

In some example embodiments, to determine that the second cell is to be accessed by the first device 205, the third device 215 may determine that the second cell is to be accessed, according to coordination with the first cell, based on at least one of: a load of the first and/or second cell, a traffic type requested by the first device, a location of the first device, or radio conditions associated with the first and/or second cell.

In some example embodiments, the third device 215 may further based on a determination that the second cell is to be accessed by the first device 205, transmit, in the second cell, an access response towards the first device, the access response indicating that the second cell is to be accessed by the first device 205.

In some example embodiments, the access response may comprise at least one of: an identification of the second cell, an indication of a first resource for transmitting the second message by the first device, an indication of availability time of the second cell, an indication of a beam for the transmission of the second message, or an indication of a timing advance for the transmission of the second message.

In some example embodiments, the third device 215 may further transmit, in the second cell, to the first device 205, an indication of a resource associated with the second cell and used for receiving the access response, via at least one of a synchronization signal block or a system information block.

In some example embodiments, to transmit the access response towards the first device 205, the third device 215 may transmit, to a second device 210 serving the first cell, the access response for the first device.

In some example embodiments, the second message may comprise at least one of: message 3 in a first random access procedure for the first access to the first cell, or message 1 in a second random access procedure for the second access to the second cell.

In some example embodiments, the first cell may comprise a coverage cell, and the second cell may comprise a capacity cell.

All operations and features as described above with reference to FIGS. 1 to 3D are likewise applicable to the methods 400, 500 and 600 and have similar effects. For the purposes of simplification, the details will be omitted.

In some example embodiments, an apparatus capable of performing the method 400 (for example, the first device 205 as shown in FIG. 2) may comprise means for performing the respective steps of the method 400. The means may be implemented in any suitable form. For example, the means may be implemented in a circuitry or software module.

In some example embodiments, the apparatus comprises means for transmitting a first message to initiate a first access to a first cell; means for receiving an access response from at least one of the first cell or a different second cell, the access response indicating that the second cell is to be accessed by the first device; and means for transmitting, to the second cell, a second message associated with a second access to the second cell.

In some example embodiments, the access response comprises at least one of: an identification of the second cell, an indication of a first resource for transmitting the second message by the first device, an indication of availability time of the second cell, an indication of a beam for the transmission of the second message, or an indication of a timing advance for the transmission of the second message.

In some example embodiments, the means for transmitting the second message comprises: means for determining, based on the availability time of the second cell, that the second cell is available; and means for based on a determination that the second cell is available, transmitting the second message to the second cell.

In some example embodiments, the apparatus further comprises: means for receiving an identification of the second cell from the first cell via at least one of system information or radio resource control signaling.

In some example embodiments, the means for receiving the access response comprises: means for monitoring for a second resource associated with the at least one of the first or second cell to receive the access response.

In some example embodiments, the second resource comprises a resource associated with the second cell, and the apparatus further comprises: means for receiving an indication of the resource associated with the second cell from at least one of the first or second cell.

In some example embodiments, the means for receiving the indication of the resource associated with the second cell comprises: means for receiving the indication of the resource associated with the second cell from the first cell via at least one of system information or radio resource control signaling.

In some example embodiments, the means for receiving the indication of the resource associated with the second cell comprises: means for receiving the indication of the resource associated with the second cell from the second cell via at least one of a synchronization signal block or system information.

In some example embodiments, the means for transmitting the second message comprises: means for transmitting, to the second cell, the second message using a beam, the beam comprising at least one of: a beam used for transmitting the first message for initiating the first access to the first cell, or a beam indicated by the access response.

In some example embodiments, the apparatus further comprises: means for before transmitting the second message, detecting, from the second cell, at least a synchronization signal block.

In some example embodiments, the means for detecting at least the synchronization signal block comprises: means for detecting, from the second cell, the synchronization signal block and a system information block.

In some example embodiments, the second message comprises at least one of: message 3 in a first random access procedure for the first access to the first cell, or message 1 in a second random access procedure for the second access to the second cell.

In some example embodiments, the first cell comprises a coverage cell, and the second cell comprises a capacity cell.

In some example embodiments, an apparatus capable of performing the method 500 (for example, the second device 210 as shown in FIG. 2) may comprise means for performing the respective steps of the method 500. The means may be implemented in any suitable form. For example, the means may be implemented in a circuitry or software module.

In some example embodiments, the apparatus comprises means for receiving, in a first cell, from a first device, a first message to initiate a first access to the first cell; and means for determining that a different second cell is to be accessed by the first device.

In some example embodiments, the apparatus further comprises: means for transmitting, to the first device, an access response from at least one of the first cell or a different second cell, the access response indicating that the second cell is to be accessed by the first device.

In some example embodiments, the access response comprises at least one of: an identification of the second cell, an indication of a first resource for transmitting, by the first device, a second message associated with a second access to the second cell, an indication of availability time of the second cell, an indication of a beam for the transmission of the second message, or an indication of a timing advance for the transmission of the second message.

In some example embodiments, the means for transmitting the access response comprises: means for generating the access response; and means for transmitting, to the first device, the random access response from the first cell.

In some example embodiments, the second cell is in a sleep or OFF mode, and the apparatus further comprises: means for transmitting, to a third device serving the second cell, a request for activating the second cell.

In some example embodiments, the apparatus further comprises: means for transmitting, to a third device serving the second cell, an indication that the second cell is to be accessed by the first device.

In some example embodiments, the apparatus further comprises: means for transmitting, to a third device serving the second cell, at least one of: an identification of the first device, an indication of a first resource for transmitting, by the first device, a second message associated with a second access to the second cell, or an indication of a timing advance for the transmission of the second message.

In some example embodiments, the second message comprises at least one of: message 3 in a first random access procedure for the first access to the first cell, or message 1 in a second random access procedure for the second access to the second cell.

In some example embodiments, the apparatus further comprises: means for receiving the access response from a third device serving the second cell. The means for transmitting the access response comprises: transmitting, to the first device, the access response from the second cell.

In some example embodiments, the apparatus further comprises: means for transmitting, to the third device, an indication of a third resource for detecting, from the first device, the first message to initiate the first access to the first cell.

In some example embodiments, the apparatus further comprises: means for transmitting, to the first device, an indication of a resource associated with the second cell and used for receiving the access response, via at least one of system information or radio resource control signaling.

In some example embodiments, the apparatus further comprises: means for transmitting, to the first device, an identification of the second cell via at least one of system information or radio resource control signaling.

In some example embodiments, the means for determining is based on at least one of: a load of the first and/or second cell, a traffic type requested by the first device, a location of the first device, or radio conditions associated with the first and/or second cell.

In some example embodiments, the means for determining is according to coordination with the second cell.

In some example embodiments, the first cell comprises a coverage cell, and the second cell comprises a capacity cell.

In some example embodiments, an apparatus capable of performing the method 600 (for example, the third device 215 as shown in FIG. 2) may comprise means for performing the respective steps of the method 600. The means may be implemented in any suitable form. For example, the means may be implemented in a circuitry or software module.

In some example embodiments, the apparatus comprises: means for determining that the second cell is to be accessed by a first device, the first device having initiated a first access to a different first cell; and means for based on a determination that the second cell is to be accessed by the first device, detecting, from the first device, a second message associated with a second access to the second cell.

In some example embodiments, the means for determining that the second cell is to be accessed by the first device comprises: means for receiving, from a second device serving the first cell, an indication that the second cell is to be accessed by the first device; and means for based on the reception of the indication, determining that the second cell is to be accessed by the first device.

In some example embodiments, the second cell is in a sleep or OFF mode, and the apparatus further comprises: means for receiving, from the second device, a request for activating the second cell; and means for based on the reception of the request, activating the second cell.

In some example embodiments, the apparatus further comprises: means for broadcasting at least a synchronization signal block in the second cell.

In some example embodiments, the means for broadcasting at least the synchronization signal block comprises: means for broadcasting the synchronization signal block and a system information block in the second cell.

In some example embodiments, the apparatus further comprises: means for receiving, from the second device, at least one of: an identification of the first device, an indication of a first resource for transmitting the second message by the first device, or an indication of a timing advance for the transmission of the second message.

In some example embodiments, the means for determining that the second cell is to be accessed by the first device comprises: means for receiving, from the second device, an indication of a third resource for detecting, from the first device, a first message to initiate the first access to the first cell; means for detecting the first message from the first device using the third resource; and means for based on the detection of the first message, determining that the second cell is to be accessed by the first device.

In some example embodiments, the means for determining that the second cell is to be accessed by the first device comprises: means for determining that the second cell is to be accessed, according to coordination with the first cell, based on at least one of: a load of the first and/or second cell, a traffic type requested by the first device, a location of the first device, or radio conditions associated with the first and/or second cell.

In some example embodiments, the apparatus further comprises: means for based on a determination that the second cell is to be accessed by the first device, transmitting, in the second cell, an access response towards the first device, the access response indicating that the second cell is to be accessed by the first device.

In some example embodiments, the access response comprises at least one of: an identification of the second cell, an indication of a first resource for transmitting the second message by the first device, an indication of availability time of the second cell, an indication of a beam for the transmission of the second message, or an indication of a timing advance for the transmission of the second message.

In some example embodiments, the apparatus further comprises: means for transmitting, in the second cell, to the first device, an indication of a resource associated with the second cell and used for receiving the access response, via at least one of a synchronization signal block or a system information block.

In some example embodiments, the means for transmitting the access response towards the first device comprises: means for transmitting, to a second device serving the first cell, the access response for the first device.

In some example embodiments, the second message comprises at least one of: message 3 in a first random access procedure for the first access to the first cell, or message 1 in a second random access procedure for the second access to the second cell.

In some example embodiments, the first cell comprises a coverage cell, and the second cell comprises a capacity cell.

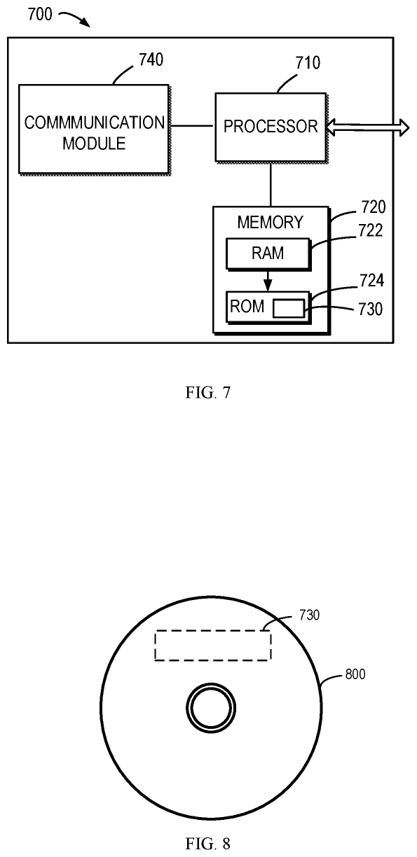

FIG. 7 is a simplified block diagram of a device 700 that is suitable for implementing example embodiments of the present disclosure. The device 700 may be provided to implement the communication device, for example the first device 310 or the second device 320 as shown in FIG. 3. As shown, the device 700 includes one or more processors 710, one or more memories 720 coupled to the processor 710, and one or more communication modules 740 coupled to the processor 710.

The communication module 740 is for bidirectional communications. The communication module 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the memory, e.g., ROM 724. The processor 710 may perform any suitable actions and processing by loading the program 730 into the RAM 722.

The example embodiments of the present disclosure may be implemented by means of the program 730 so that the device 700 may perform any process of the disclosure as discussed with reference to FIGS. 1 to 6. The example embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8 shows an example of the computer readable medium 800 in form of CD or DVD. The computer readable medium 1200 has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 400 to 600 as described above with reference to FIGS. 1-6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-49. (canceled)

50. A first device, comprising:
at least one processor; and
at least one memory storing instructions that, when executed by the at least one processor, cause the first device at least to perform:
transmitting a first message to initiate a first access to a first cell;
receiving an access response from at least one of the first cell or a different second cell, the access response indicating that the second cell is to be accessed by the first device; and
transmitting, to the second cell, a second message associated with a second access to the second cell.

51. The first device of claim 50, wherein the access response comprises at least one of:
an identification of the second cell,
an indication of a first resource for transmitting the second message by the first device,
an indication of availability time of the second cell,
an indication of a beam for the transmission of the second message, or
an indication of a timing advance for the transmission of the second message.

52. The first device of claim 51, wherein transmitting the second message comprises:
determining, based on the availability time of the second cell, that the second cell is available; and
based on a determination that the second cell is available, transmitting the second message to the second cell.

53. The first device of claim 50, wherein the first device is further caused to perform:
receiving an identification of the second cell from the first cell via at least one of system information or radio resource control signaling.

54. The first device of claim 50, wherein receiving the access response comprises:
monitoring for a second resource associated with the at least one of the first or second cell to receive the access response.

55. The first device of claim 50, wherein transmitting the second message comprises:
transmitting, to the second cell, the second message using a beam, the beam comprising at least one of:
a beam used for transmitting the first message for initiating the first access to the first cell, or
a beam indicated by the access response.

56. The first device of claim 50, wherein the first device is further caused to perform:
before transmitting the second message, detecting, from the second cell, at least a synchronization signal block.

57. A second device, comprising:
at least one processor; and
at least one memory storing instructions that, when executed by the at least one processor, cause the second device at least to perform:
receiving, in a first cell, from a first device, a first message to initiate a first access to the first cell; and
determining that a different second cell is to be accessed by the first device.

58. The second device of claim 57, further comprising:
transmitting, to the first device, an access response from at least one of the first cell or a different second cell, the access response indicating that the second cell is to be accessed by the first device.

59. The second device of claim 57, wherein the access response comprises at least one of:
an identification of the second cell,
an indication of a first resource for transmitting, by the first device, a second message associated with a second access to the second cell,
an indication of availability time of the second cell,
an indication of a beam for the transmission of the second message, or
an indication of a timing advance for the transmission of the second message.

60. The second device of claim 57, wherein the second device is further caused to perform:
transmitting, to a third device serving the second cell, an indication that the second cell is to be accessed by the first device.

61. The second device of claim 57, wherein the second device is further caused to perform:
transmitting, to a third device serving the second cell, at least one of:
an identification of the first device,
an indication of a first resource for transmitting, by the first device, a second message associated with a second access to the second cell, or
an indication of a timing advance for the transmission of the second message.

62. The second device of claim 57, wherein the second device is further caused to perform:
transmitting, to the first device, an identification of the second cell via at least one of system information or radio resource control signaling.

63. The second device of claim 57, wherein the determining is performed based on at least one of:
a load of the first and/or second cell,
a traffic type requested by the first device,
a location of the first device, or
radio conditions associated with the first and/or second cell.

64. A third device, comprising:
at least one processor; and
at least one memory storing instructions that, when executed by the at least one processor, cause the third device at least to perform:
determining that a second cell served by the third device is to be accessed by a first device, the first device having initiated a first access to a different first cell; and
based on a determination that the second cell is to be accessed by the first device, detecting, from the first device, a second message associated with a second access to the second cell.

65. The third device of claim 64, wherein determining that the second cell is to be accessed by the first device comprises:
receiving, from a second device serving the first cell, an indication that the second cell is to be accessed by the first device; and
based on the reception of the indication, determining that the second cell is to be accessed by the first device.

66. The third device of claim 65, wherein the second cell is in a sleep or OFF mode, and the third device is further caused to perform:
receiving, from the second device, a request for activating the second cell; and
based on the reception of the request, activating the second cell.

67. The third device of claim 64, wherein the third device is further caused to perform: receiving, from the second device, at least one of:
an identification of the first device,
an indication of a first resource for transmitting the second message by the first device, or
an indication of a timing advance for the transmission of the second message.

68. The third device of claim 64, wherein determining that the second cell is to be accessed by the first device comprises:
receiving, from the second device, an indication of a third resource for detecting, from the first device, a first message to initiate the first access to the first cell;
detecting the first message from the first device using the third resource; and
based on the detection of the first message, determining that the second cell is to be accessed by the first device.

69. The third device of claim 64, wherein the second message comprises at least one of:
message 3 in a first random access procedure for the first access to the first cell, or
message 1 in a second random access procedure for the second access to the second cell.
